(19) United States
(12) Patent Application Publication
(10) Pub. No.: US 2009/0199043 A1
(43) Pub. Date: Aug. 6, 2009

(54) ERROR CORRECTION IN AN INTEGRATED CIRCUIT WITH AN ARRAY OF MEMORY CELLS

(76) Inventors: Peter Schrogmeier, Munich (DE); Jan Boris Philipp, Munich (DE); Thomas Happ, Dresden (DE); Luca DeAmbroggi, Munich (DE); Christian Pho Duc, Hohenkirchen-Siegertsbrunn (DE); Franz Kreupl, Munich (DE); Gernot Steinlesberger, Otterfing (AT)

Correspondence Address: DICKE, BILLIG & CZAJA, FIFTH STREET TOWERS, 100 SOUTH FIFTH STREET, SUITE 2250, MINNEAPOLIS, MN, 55402, US

(21) Appl. No.: 12/023,523

(22) Filed: Jan. 31, 2008

(51) Int. Cl. G06F 11/00

(52) U.S. Cl. 714/8; 714/E11.001

(57) ABSTRACT

An integrated circuit includes an array of memory cells, and an error correction code circuit configured to correct errors in data read from the array based at least in part on a map that identifies locations of erratic memory cells in the array.

### BACKGROUND

Since memory devices may have a certain probability of bit read or write errors when being operated, some memory devices use error correction codes (“ECC”) to detect and correct errors. In these devices, the ECC circuitry typically produces parity bits associated with the data being stored and stores the parity bits along with the original data. When reading the data from the array, the device uses the data's associated parity bits to recover data lost because of errors produced when either programming or reading the data. The number of erroneous bits in a data word that can be corrected depends on the error correction technique that is used.

One example of an ECC algorithm is a Hsiao code, which is based on a Hamming code. In one example Hsiao code, for each group of four 8-bit data words (i.e., 32 bits), seven parity bits are computed. This 32+7 code makes it possible to detect two errors and correct one error. The efficiency of this code is relatively low, since it can only repair a single bit error in a 32-bit block of data. Other codes are available that use more parity bits, and that are able to correct more errors. However, the use of additional parity bits results in more chip space being allocated to such bits and higher chip costs.

### SUMMARY

One embodiment provides an integrated circuit. The integrated circuit includes an array of memory cells, and an error correction code circuit configured to correct errors in data read from the array based at least in part on a map that identifies locations of erratic memory cells in the array.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIG. 1 is a block diagram illustrating a system with a memory device according to one embodiment.

FIG. 2 is a diagram illustrating a memory device according to one embodiment.

FIG. 3 is a diagram illustrating the organization of a memory array of a memory device according to one embodiment.

FIG. 4 is a flow diagram illustrating a method of correcting errors in a memory device according to one embodiment.

FIG. 5 is a flow diagram illustrating a method of correcting errors in a memory device according to another embodiment.

FIG. 6 is a diagram illustrating the organization of a memory array of a memory device according to another embodiment.

FIG. 7 is a flow diagram illustrating a method of correcting errors in a memory device according to another embodiment.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

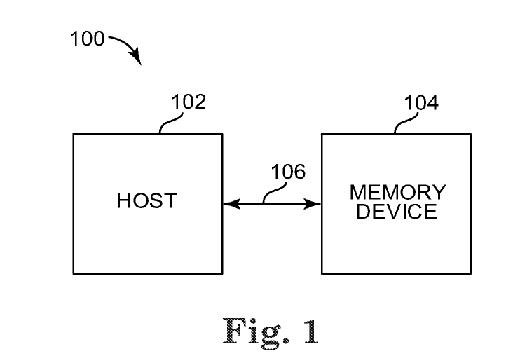

FIG. 1 is a block diagram illustrating a system 100 according to one embodiment. System 100 includes a host 102 and a memory device 104. Host 102 is communicatively coupled to memory device 104 through communication link 106. Host 102 includes a computer (e.g., desktop, laptop, handheld), portable electronic device (e.g., cellular phone, personal digital assistant (PDA), MP3 player, video player, digital camera), or any other suitable device that uses memory. Memory device 104 provides memory for host 102. In one embodiment, memory device 104 is a phase-change random access memory (PCRAM) non-volatile memory device.

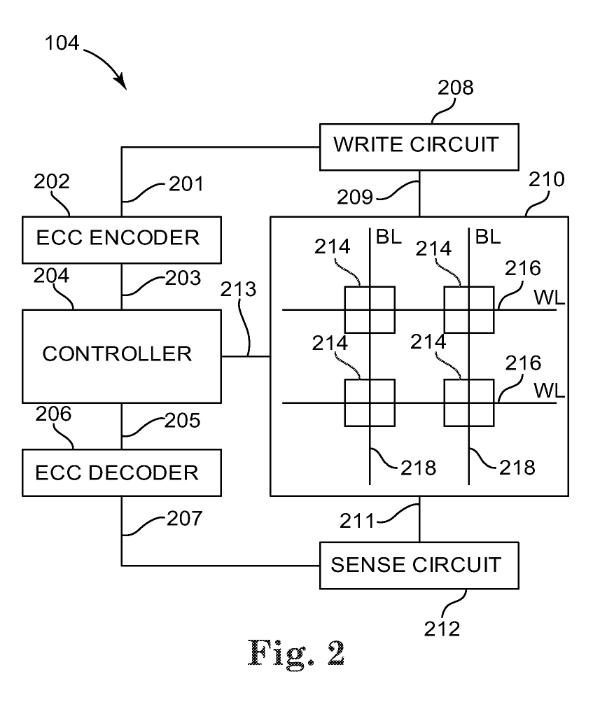

FIG. 2 is a diagram illustrating a memory device 104 according to one embodiment. In one embodiment, memory device 104 is an integrated circuit or part of an integrated circuit. Memory device 104 includes error correction code (ECC) encoder 202, controller 204, ECC decoder 206, write circuit 208, memory array 210, and a sense circuit 212. In the illustrated embodiment, memory array 210 includes a plurality of memory cells 214, a plurality of word lines (WLs) 216, and a plurality of bit lines (BLs) 218.

As used herein, the term “electrically coupled” is not meant to mean that the elements must be directly coupled together and intervening elements may be provided between the “electrically coupled” elements.

Controller 204 is electrically coupled to ECC encoder 202 through signal path 203 and to ECC decoder 206 through signal path 205. ECC encoder 202 is electrically coupled to write circuit 208 through signal path 201. ECC decoder 206 is electrically coupled to sense circuit 212 through signal path 207. Memory array 210 is electrically coupled to write circuit 208 through signal path 209, to controller 204 through signal path 213, and to sense circuit 212 through signal path 211. Each memory cell 214 is electrically coupled to a word line 216 and a bit line 218.

For a write operation according to one embodiment, ECC encoder 202 receives data to write to memory array 210 from controller 204 through signal path 203. ECC encoder 202 generates parity information for the received data and passes the data and the corresponding parity information to write circuit 208 through signal path 201. In one embodiment, ECC encoder 202 uses a Reed Solomon code to generate the parity information. In other embodiments, ECC encoder 202 uses another suitable algorithm to generate the parity information. Write circuit 208 writes the data to a data portion of memory array 210 and writes the parity information to a parity information portion of memory array 210.

For a read operation according to one embodiment, ECC decoder 206 receives via signal path 207 data and the corresponding parity information for the data, which is read from memory array 210 by sense circuit 212 via signal path 211. ECC decoder 206 decodes the parity information to detect and correct bit failures within the data. In one embodiment, ECC decoder 206 is configured to detect and correct multiple bit failures within the data. ECC decoder 206 passes the corrected data to controller 204 through signal path 205.

Controller 204 includes a microprocessor, microcontroller, or other suitable logic circuitry for controlling the operation of memory device 104. Controller 204 controls read and write operations of memory device 104, including the application of control and data signals to memory array 210 through write circuit 208 and sense circuit 212. In one embodiment, write circuit 208 provides voltage pulses through signal path 209 and bit lines 218 to memory cells 214 to program the memory cells. In other embodiments, write circuit 208 provides current pulses through signal path 209 and bit lines 218 to memory cells 214 to program the memory cells. In one embodiment, sense circuit 212 reads the states of memory cells 214 through bit lines 218 and signal path 211.

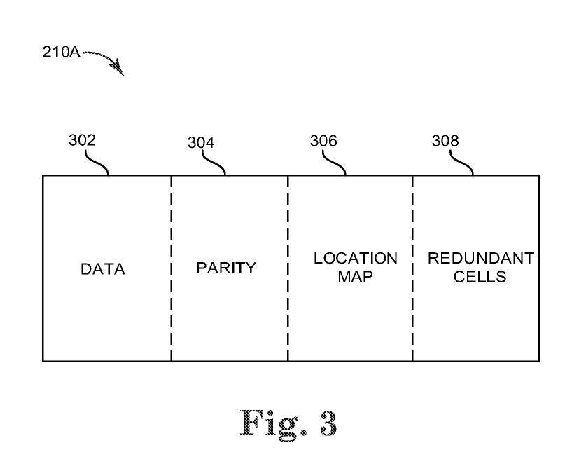

FIG. 3 is a diagram illustrating the organization of memory array 210 of memory device 104 according to one embodiment. The embodiment of the memory array 210 shown in FIG. 3 is identified by reference number 210A. In the illustrated embodiment, the memory cells 214 are divided into memory cells used to store data as indicated at 302, memory cells used to store parity information for the data as indicated at 304, memory cells used to store a location map as indicated at 306, and redundant memory cells as indicated at 308. Some memory devices include problematic memory cells. The problematic memory cells include memory cells that always fail (i.e., causing permanent errors), and erratic memory cells that intermittently fail (and intermittently work correctly). In one embodiment, memory cells 214 in memory device 104 that always fail are identified during testing of the device 104 and replaced by redundant memory cells 308. The memory cells can be replaced by redundant cells at the wafer level (e.g., prior to packaging) or at the integrated circuit level.

An erratic memory cell or erratic bit is one that exhibits erratic behavior (e.g., intermittently fails or does not operate in a normal manner). In one embodiment, location map 306 stores the locations of memory cells 214 that are identified as being erratic. In one embodiment, erratic memory cells are identified in production tests, such as performing read operations under intensified conditions, performing write operations under intensified conditions followed by read operations at normal or intensified conditions, and performing repeated write and read operations under varying conditions. Such intensified conditions include higher or lower than normal temperatures, higher or lower than normal voltages, reducing the reset current, shortening the set pulses, as well as other conditions.

In one embodiment, during testing, memory cells that appear weak and that do not necessarily fail during the testing, but are likely to fail in the future, are also identified. These potentially erratic memory cells are identified in one embodiment by performing read operations and looking at various characteristics, including data eye widths and asynchronous access speeds. The locations of these potentially erratic memory cells are also stored in location map 306 in one embodiment. In one embodiment, memory device 104 is a non-volatile memory device or includes a non-volatile memory device so that information stored therein, such as the location map 306, is not lost when the device is powered off.

In some ECC codes, such as a Reed Solomon code, one redundant symbol is used in detecting and locating each error, and another redundant symbol is used in identifying the correct value for that error. When a Reed Solomon decoder is informed that a specific data symbol is an error (such a known error is sometimes referred to as an erasure), the decoder only has to use one redundant symbol to correct that error, and since the location of the error was known in advance, an additional redundant symbol for location is not needed. If the locations of all errors are provided to the decoder, the decoder can correct twice as many errors as it could without being given these known error locations.

In one embodiment, ECC decoder 206 (FIG. 2) is configured to use the location map 306 to enhance the error detection and correction process. When a read operation is performed, ECC decoder 206 receives the data requested by the read operation, the parity bits associated with the data, and the location map 306 (or the portions of the location map 306 relevant to the received data). By knowing the locations of erratic memory cells 214 in memory array 210, ECC decoder 206 is able to correct more errors in the received data than it could without having this information. In one embodiment, ECC decoder 206 is configured to ignore the read out values from memory cells 214 that are identified by location map 306 as being erratic.

The number of additional bits that are used to store the location map 306 is relatively small compared to the number of additional parity bits that would need to be added to make the error correction as efficient as it is when the location of erratic bits is known. By using location map 306, more errors can be corrected without adding more parity bits. In one embodiment, ECC decoder 206 is configured to correct twice as many errors using location map 306 than it could without such a map.

As mentioned above, in one embodiment, memory cells 214 that always fail are replaced by redundant memory cells 308, and the locations of erratic memory cells 214 are stored in location map 306. In another embodiment, the locations of memory cells 214 that always fail and the locations of erratic memory cells 214 are both stored in the location map 306. When redundant cells are used to replace memory cells 214 that always fail, an entire bit line or an entire word line containing those memory cells may be replaced. Thus, hundreds of redundant memory cells might be used to correct a single defective memory cell. In contrast, by storing the locations of the memory cells 214 that always fail in the location map 306, a more efficient solution is provided.

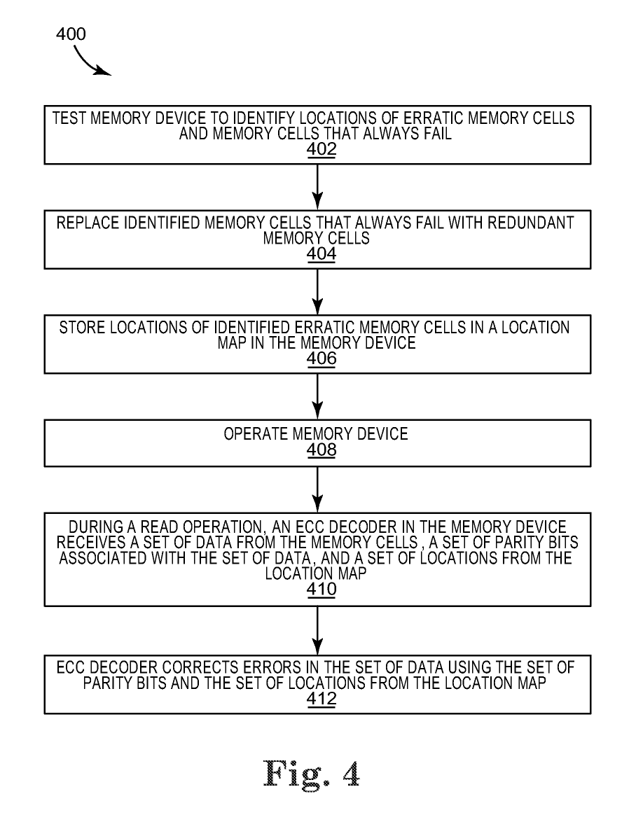

FIG. 4 is a flow diagram illustrating a method 400 of correcting errors in a memory device 104 according to one embodiment. At 402, the memory device 104 is tested to identify the locations of erratic memory cells 214 and memory cells 214 that always fail. At 404, the identified memory cells 214 that always fail are replaced by redundant memory cells 308. At 406, the locations of the erratic memory cells 214 identified at 402 are stored in a location map 306 in the memory device 104. At 408, the memory device 104 is operated. At 410, during a read operation, an ECC decoder 206 in memory device 104 receives a set of data from memory cells 214 in the memory device 104, a set of parity bits associated with the set of data, and a set of locations from the location map 306. At 412, the ECC decoder 206 corrects errors in the set of data using the set of parity bits and the set of locations from the location map 306.

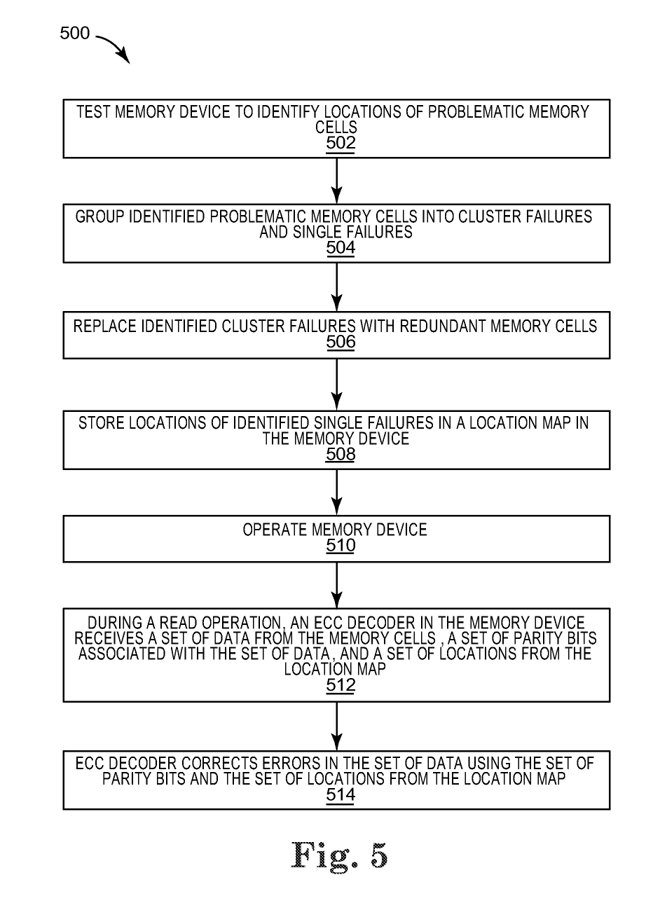

FIG. 5 is a flow diagram illustrating a method 500 of correcting errors in a memory device 104 according to another embodiment. At 502, the memory device 104 is tested to identify the locations of problematic memory cells 214. In one embodiment, the problematic memory cells 214 are erratic memory cells. In another embodiment, the problematic memory cells 214 are erratic memory cells and memory cells that always fail. At 504, the identified problematic memory cells 214 are grouped into cluster failures and single failures. A cluster failure according to one embodiment is a plurality of problematic memory cells in close proximity to each other, such as along the same word line or the same bit line. A single failure according to one embodiment is a single problematic memory cell with no other problematic memory cells in close proximity. At 506, the cluster failures identified at 504 are replaced by redundant memory cells 308. At 508, the locations of the single failures identified at 504 are stored in a location map 306 in the memory device 104. At 510, the memory device 104 is operated. At 512, during a read operation, an ECC decoder 206 in memory device 104 receives a set of data from memory cells 214 in the memory device 104, a set of parity bits associated with the set of data, and a set of locations from the location map 306. At 514, the ECC decoder 206 corrects errors in the set of data using the set of parity bits and the set of locations from the location map 306.

For certain types of memory devices, such as some PCRAM, MRAM, CDRAM, and FRAM devices, erratic memory cells have a preferred error direction that is more likely to occur than a non-preferred error direction. This means that it is more likely that a stored “1” will be read as a “0” than a stored “0” will be read as a “1”, or that it is more likely that a stored “0” will be read as a “1” than a stored “1” will be read as a “0”. In one embodiment, a memory cell that stores a “0”, but that is read as a “1”, will be referred to as a memory cell or bit that has failed in the preferred error direction or the set direction, and a memory cell that stores a “1”, but that is read as a “0”, will be referred to as a memory cell or bit that has failed in the non-preferred error direction or the reset direction. As described above with respect to FIG. 3, various tests may be performed on memory device 104 to identify the locations of erratic bits. In one embodiment, in addition to identifying the locations of erratic bits, for each of the erratic bits, it is determined during testing whether the erratic bit fails in the preferred error direction or fails in the non-preferred error direction.

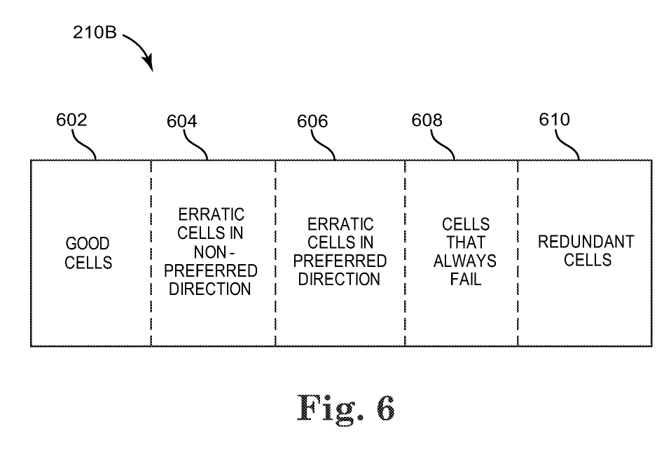

FIG. 6 is a diagram illustrating the organization of memory array 210 of memory device 104 according to another embodiment. The embodiment of the memory array 210 shown in FIG. 6 is identified by reference number 210B. In the illustrated embodiment, the memory cells 214 are divided into good memory cells that have not failed as indicated at 602, erratic memory cells that fail in the non-preferred direction as indicated at 604, erratic memory cells that fail in the preferred direction as indicated at 606, memory cells that always fail as indicated at 608, and redundant memory cells as indicated at 610.

In one embodiment, ECC decoder 206 (FIG. 2) is configured to use the preferred error direction of the memory device 104 during the error detection and correction process. By taking the preferred error direction into account, ECC decoder 206 is able to correct more errors in the received data than is possible without using this information, and the additional errors can be detected without adding more parity bits. In one embodiment, the erratic memory cells 604 that fail in the non-preferred error direction and the memory cells 608 that always fail are replaced by redundant memory cells 610, and the erratic memory cells 606 that fail in the preferred error direction remain un-repaired. During operation according to one embodiment, ECC decoder 206 performs a one-directional error correction process to correct errors produced by the erratic memory cells 606 that fail in the preferred error direction. In one embodiment, ECC decoder 206 performs error correction by taking into account both the error direction of memory cells 214, but also a location map 306 that identifies the location of erratic memory cells.

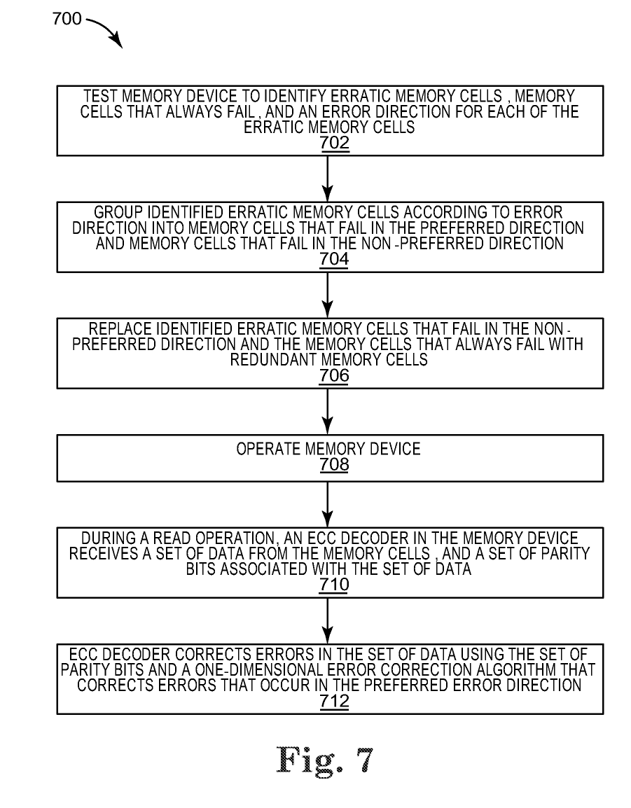

FIG. 7 is a flow diagram illustrating a method 700 of correcting errors in a memory device 104 according to another embodiment. At 702, the memory device 104 is tested to identify erratic memory cells, memory cells that always fail, and an error direction for each of the erratic memory cells. At 704, the identified erratic memory cells are grouped according to error direction into memory cells that fail in the preferred error direction and memory cells that fail in the non-preferred error direction. In one embodiment, the preferred error direction is in the set direction, and the non-preferred error direction is in the reset direction. At 706, the identified memory cells that fail in the non-preferred error direction and the memory cells that always fail are replaced by redundant memory cells, and the identified memory cells that fail in the preferred direction remain un-repaired. At 708, the memory device 104 is operated. At 710, during a read operation, an ECC decoder 206 in memory device 104 receives a set of data from memory cells 214 in the memory device 104, and a set of parity bits associated with the set of data. At 712, the ECC decoder 206 corrects errors in the set of data using the set of parity bits and a one-directional error correction algorithm that corrects errors that occur in the preferred error direction.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. An integrated circuit comprising:
an array of memory cells; and
an error correction code circuit configured to correct errors in data read from the array based at least in part on a map that identifies locations of erratic memory cells in the array.

2. The integrated circuit of claim 1, wherein the erratic memory cells are identified during testing as exhibiting erratic behavior.

3. The integrated circuit of claim 2, wherein the erratic memory cells intermittently fail.

4. The integrated circuit of claim 1, wherein the map is stored in the array of memory cells.

5. The integrated circuit of claim 1, wherein the map also identifies locations of memory cells that always fail.

6. The integrated circuit of claim 1, wherein the array includes a plurality of redundant memory cells configured to replace memory cells that always fail.

7. The integrated circuit of claim 6, wherein the redundant memory cells are configured to repair cluster failures, and the map is configured to correct single failures.

8. The integrated circuit of claim 1, wherein the error correction code circuit is configured to receive a set of data from the array, a set of parity bits associated with the set of data, and a set of locations from the map, during a read operation.

9. The integrated circuit of claim 1, wherein the error correction code circuit is configured to correct errors based on an error direction of the errors.

10. The integrated circuit of claim 9, wherein erratic memory cells that fail in a non-preferred error direction are repaired by redundant memory cells, and erratic memory cells that fail in a preferred error direction are corrected by the error correction code circuit.

11. The integrated circuit of claim 1, wherein the array comprises an array of phase change memory cells.

12. An integrated circuit comprising:
an array of memory cells including a first set of erratic memory cells that have a first error direction, and a second set of erratic memory cells that have a second error direction; and
an error correction code circuit configured to correct errors in data read from the array based at least in part on an error direction of each error.

13. The integrated circuit of claim 12, wherein the array of memory cells further comprises:
a set of redundant memory cells configured to replace the first set of erratic memory cells.

14. The integrated circuit of claim 13, wherein the error correction code circuit is configured to only correct errors that occur in the second error direction.

15. The integrated circuit of claim 1, wherein the error correction code circuit is configured to correct errors in data read from the array based at least in part on a map that identifies locations of erratic memory cells in the array.

16. The integrated circuit of claim 15, wherein the map is stored in the array of memory cells.

17. The integrated circuit of claim 15, wherein the erratic memory cells intermittently fail, and wherein the map also identifies locations of memory cells that always fail.

18. The integrated circuit of claim 15, wherein the array includes a set of redundant memory cells configured to replace memory cells that always fail.

19. The integrated circuit of claim 12, wherein the array comprises an array of phase change memory cells.

20. A system comprising:
a host; and
a memory device communicatively coupled to the host, the memory device comprising:
an array of memory cells; and
an error correction code circuit configured to correct errors in data read from the array based on a location map that identifies locations of erratic memory cells in the array, and based on an error direction of the errors.
